(19) United States
(12) Patent Application Publication
(10) Pub. No.: US 2026/0177496 A1
(43) Pub. Date: Jun. 25, 2026

(54) INSPECTION SYSTEM AND CONTROL SYSTEM FOR REJECTING DISTURBANCES AND ATTENUATING DISTURBANCE-INDUCED ERRORS THEREIN

(71) Applicant: Applied Materials Israel Ltd., Rehovot (IL)

(72) Inventors: Dan Solodky, Tel Aviv (IL); Ilan Selig, Modiin (IL); Per Olof Gutman, Haifa (IL)

(73) Assignee: Applied Materials Israel Ltd., Rehovot (IL)

(21) Appl. No.: 19/000,444

(22) Filed: Dec. 23, 2024

(51) Int. Cl. G01N 21/88

(52) U.S. Cl. CPC G01N 21/8806; G01N 2201/025

(57) ABSTRACT

An inspection system configured to scan a sample is provided. The inspection system comprises a scanning arrangement configured to image one or more physical parameters of the sample, a stage configured to maintain the sample in a suitable position relative to the scanning arrangement during operation thereof, one or more actuators configured to effect relative motion between the sample and the scanning arrangement, a system controller configured to direct operation of the inspection system, and a feedback controller configured to attenuate disturbances arising from relative-motion-induced disturbances. The feedback controller is a non-minimum phase controller, with one or more of its zeros being in the right-half plane.

### TECHNICAL FIELD

The presently disclosed subject matter relates to inspection systems, and in particular to feedback controllers to reject disturbances and to attenuate disturbance-induced errors.

### BACKGROUND OF THE INVENTION

As semiconductor feature sizes continue to decrease, nanoscale inspection becomes an increasingly important contributor to process and device design yield, in particular regarding defect detection. In order to scan a wafer which is larger than the field of view of an inspection device, the wafer may be held on a stage mechanism during scanning, which is moved relative to the inspection device's aperture. Typically, the stage mechanism comprises a stage which is moved by a plurality of actuators, including, e.g., piezoelectric and other actuators.

The throughput of a scanning process, especially when operating to detect features and defects at micro- and nanoscales, may be negatively affected by disturbances during scanning which give rise to errors such as jitter, vibrations, etc. Such disturbances may arise from a variety of sources, such as mechanical vibrations, high scanning speeds and/or acceleration, and resonance phenomena.

### BRIEF SUMMARY OF THE INVENTION

According to an aspect of the presently disclosed subject matter there is provided an inspection system configured to scan a sample, the inspection system comprising:
a scanning arrangement configured to image one or more physical parameters of the sample;
a stage configured to maintain the sample in a suitable position relative to the scanning arrangement during operation thereof;
one or more actuators configured to effect relative motion between the sample and the scanning arrangement;
a system controller being configured to direct operation of the inspection system; and
a feedback controller configured to attenuate errors arising from relative-motion-induced disturbances, the feedback controller being a non-minimum phase controller having one or more zeros in the right-half plane.

It will be appreciated that the term “image” when used herein as a verb is to be construed in the broad sense of meaning “to produce a representation of.” The representation produced may include, but is not limited to, a visual representation (i.e., an image), a three-dimensional computer model, a defect map, measurements, physical parameters, and/or material parameters.

The errors may include, but are not limited to, jitter and/or vibrations.

The actuators may be piezoelectric actuators.

The feedback controller and moving elements (e.g., actuators) of the inspection system may constitute a closed-loop control system, in which the moving elements of the inspection system constitute a plant of the closed-loop control system.

The one or more actuators may be characterized by one or more resonance frequencies, the feedback controller being further characterized by a high gain and by a phase shift which gives rise to an open-loop frequency response of the system having a phase which is a positive-integer multiple of −360°, ±90° (i.e., the permissible limit of variation in the phase is ±90° of the positive-integer multiple of −360°, e.g., between −270° and −450°, between −630° and −810°, between −990 and −1170°, etc.), at each of the resonance frequencies, i.e., the open-loop transfer function of the control system may have a phase shift which is a positive-integer multiple of −360°, ±90°, at each of the resonance frequencies. This may be realized, e.g., by providing the feedback controller such that errors induced by the resonance frequencies are each of associated with a corresponding non-minimum phase controller configured to attenuate it. According to some examples, the phase of the open-loop frequency response is a positive-integer multiple of −360, +45°. According to some examples, the phase of the open-loop frequency response at one or more of the resonance frequencies is a positive-integer multiple of −360, ±15°. According to some examples, the phase of the open-loop frequency response at one or more of the resonance frequencies is substantially a positive-integer multiple of −360°. In this connection, a phase may be considered to be “substantially,” “about,” or any similar expression, a given value if it is sufficiently close thereto such that an open-loop frequency response having a phase which is closer to the given value would not be expected to provide noticeably better error attenuation. According to any of these examples, the positive integer is 1.

The feedback controller may be characterized by a transfer function C(s), the plant being characterized by a transfer function P(s), wherein the closed-loop control system is characterized by:

$$y / r = C ( s ) P ( s ) / ( 1 + C ( s ) P ( s ) ) ,$$

in which y is the movement, e.g., the position and/or velocity, of the stage relative to the scanning arrangement, and r is the directions provided by the system controller regarding movements of the one or more actuators.

The closed-loop control system may be further characterized by:

$$y / d = P ( s ) / ( 1 + C ( s ) P ( s ) ) ,$$

in which d is the equivalent disturbance.

Inputs to the plant may comprise the output of the feedback controller and the disturbance.

Inputs to the feedback controller may comprise directions provided by the system controller regarding movements of the one or more actuators, and negative of the output of the plant.

The feedback controller may be implemented via software and/or hardware.

The scanning arrangement may be configured to remain stationary during scanning.

The inspection system may further comprise a stage mechanism comprising the stage and the one or more actuators.

The one or more actuators may be configured, during scanning, to move the sample linearly in a first direction, and to subsequently reverse direction to move the sample linearly in a second direction being opposite the first direction.

The one or more actuators may be further configured, after linearly moving the sample in the first direction, to shift the sample in a direction being perpendicular to the first and second linear directions.

Disturbances may arise from the reversal of direction.

The one or more actuators may be configured, during scanning, to move the sample rotationally, wherein disturbances arise from the rotation.

The inspection system may be configured to attenuate residual errors remaining after motion has stopped. This may be useful, i.e., in point-to-point scanning, wherein the scanning arrangement scans moves to a location and remains in place while scanning.

The stage may be characterized by a resonance frequency about one or more axes thereof, the feedback controller being configured to attenuate errors having a frequency substantially that of the resonance frequency and/or disturbance causing them.

The scanning arrangement may be configured to implement scanning electron microscopy, scanning tunneling microscopy, scanning photon microscopy, atomic force microscopy, soft X-ray metrology, X-ray reflectometry, X-ray tomography, X-ray diffraction, coherent diffractive imaging, ptychography, and/or extreme ultraviolet metrology.

The scanning arrangement may comprise an aperture via which signals from the samples are collected for detection, wherein the one or more actuators are configured to effect relative motion between the sample and the scanning aperture.

The inspection system may be configured to facilitate detection of defects on the sample.

The inspection system may be configured to facilitate measurement of features of the sample, e.g., it may constitute or comprise a metrology system.

The sample may comprise a semiconductor wafer, an integrated circuit, or a printed circuit board.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates an inspection system according to the presently disclosed subject matter; and

FIG. 2 schematically illustrates a closed-loop feedback control system modeling the inspection system illustrated in FIG. 1.

### DETAILED DESCRIPTION OF THE INVENTION

The presently disclosed subject matter is generally directed towards feedback controllers, and systems implementing such feedback controllers, for reducing vibrations in inspection systems. While they may be particularly useful in those systems which operate at micro- and/or nanoscales, they are not limited to such systems. The feedback controllers may be useful for optical inspections systems used in conjunction with semiconductor manufacturing. Such systems may comprise elements which scan from side-to-side, rotate, etc., causing disturbances during use which give rise to errors such as vibrations, jitter, etc.

Feedback controllers according to the presently disclosed subject matter are configured to quickly attenuate such errors. They are non-minimum phase controllers having one or more zeros in the right-half plane. This allows, e.g., the operation of systems at high velocities, thereby achieving higher throughput while maintaining image quality, accuracy, etc., otherwise achievable at lower velocities.

It will be appreciated that the preceding is provided as an introductory overview to provide a general synopsis of the presently disclosed subject matter. Accordingly, it is not to be construed as limiting. Similarly, the inclusion of specific details therein, exclusion of specific details therefrom, generalizations, particularizations, etc., are not to be construed as limiting.

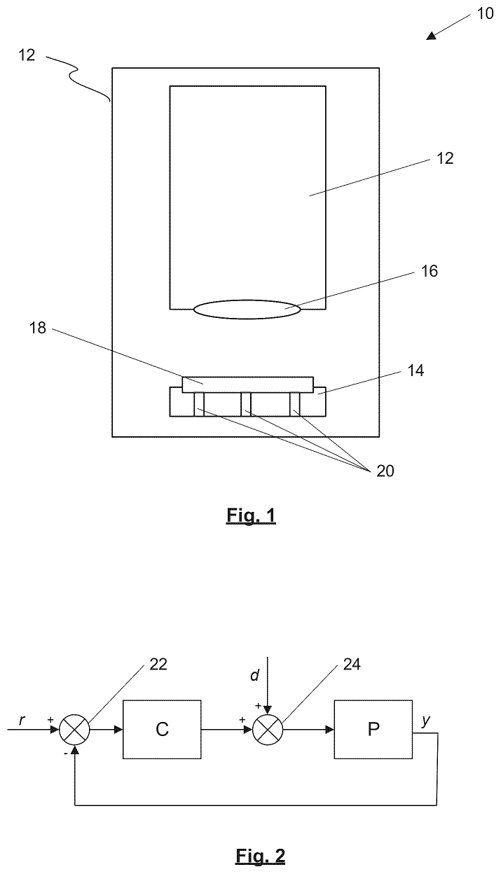

As illustrated in FIG. 1, there is provided an inspection system, which is generally indicated at 10. The inspection system 10 is configured to scan a sample, for example a semiconductor wafer, using one or more suitable scanning technologies.

The inspection system 10 comprises a scanning arrangement 12, a stage mechanism 14 configured to hold the sample, and a system controller (not illustrated) configured to direct operation of the components of the system, in particular to direct operation of the stage mechanism.

The scanning arrangement 12 is configured to scan the sample and image one or more physical parameters thereof, for example to determine its three-dimensional structure, identify defects, measure, etc. The scanning arrangement 12 may be configured to implement any one or more suitable technologies for example as known in the art, including, but not limited to, scanning electron microscopy, scanning tunneling microscopy, scanning photon microscopy, atomic force microscopy, soft X-ray metrology, X-ray reflectometry, X-ray tomography, X-ray diffraction, coherent diffractive imaging, ptychography, and extreme ultraviolet metrology.

Typically, the scanning arrangement 12 comprises, inter alia, an aperture 16 facing the sample, via which, e.g., radiation from the sample which is used to image it is collected. While some scanning technologies may customarily use a different term for the element and/or mechanism which performs this function, herein the specification and appended claims the term “aperture” is used as a generic term for the element/mechanism of the scanning arrangement 12 which faces the sample, and via which detected signals are collected by the scanning arrangement for detection, processing, etc.

The stage mechanism 14 is configured to hold the sample in a suitable position to be scanned by the scanning arrangement 12, and to move it with respect to the scanning arrangement in order to facilitate scanning a larger portion of its surface, e.g., the entire surface, than the field of view of the scanning arrangement would permit. Accordingly, the stage mechanism 14 comprises a stage 18 and a plurality of actuators 20, for example piezoelectric actuators, configured to selectively move the stage.

While in practice the stage mechanism 14 may comprise a plurality of stages, for example one for movement along an X-axis, one for movement along a Y-axis, and one for rotation, herein the specification and appended claims the term “stage” will be used to refer to some or all of the stages of the stage mechanism collectively, and should not be construed as limiting the scope of the presently disclosed subject matter to a stage mechanism comprising a single stage, mutatis mutandis.

Typically, the stage mechanism 14 operates its actuators 20 to move the stage 18 to facilitate an alternatingly traversing scan across the surface of the sample, i.e., the stage is moved along the Y-axis in a first direction, thereby facilitating scanning along a scan line; the stage is then moved a small amount along the X-axis, thereby shifting the sample; the stage is then moved along the Y-axis in a direction opposite the first direction, thereby facilitating scanning along a subsequent scan line, e.g., being parallel to the previous scan line. This process is repeated, wherein the direction of movement of the stage 18 reverses between successive scans.

During scanning, the movement of the stage 18 may give rise to disturbances that cause errors in its movement, for example in-phase jitters and/or vibrations. According to some examples, the movement of the stage 18 during the reversal, i.e., when the direction of movement along the Y-axis changes between successive scans, may induce one or more resonances, e.g., the resonance frequencies of the stage mechanism 14.

According to some examples, the stage mechanism 14 is characterized by one or more resonance frequencies along a rotational axis. Resonance is manifested during the reversal, and may have a phase shift of −180°. While the jitter caused by the resonance may naturally attenuate over time, scanning of the sample is negatively affected until it falls below an acceptable threshold, thereby reducing the throughput of the system 10.

One or more resonances may arise during other operations of the system 10. For example, during acceleration of the stage 18, or when the stage moves at an unduly elevated speed, etc.

As illustrated in FIG. 2, the system controller may comprise a feedback controller, indicated schematically by C. The feedback controller C defines a feedback transfer function C(s). It may be implemented via software, e.g., as part of a firmware of the system controller, or via hardware, and in any suitable fashion, including, but not limited to, by one or more microcontrollers, by one or more programmable logic controllers, field programmable gate arrays, using a plurality of electronic components, etc., for example as is well known in the art.

As further seen in FIG. 2, the inspection system 10 may be modeled as a closed-loop control system, wherein moving elements of the inspection system, for example including, but not limited to, the actuators 20 of the stage mechanism 14, the stage 18, etc., are represented as the plant P. The plant P defines a plant transfer function P(s). Instructions from the system controller, in particular regarding movement of the stage 18, are represented as an input r to the control system. The input r to the system may be embodied as directions provided by the control system regarding movement of the piezoelectric actuators 20 of the stage mechanism 14. The motion of the stage 18 is represented as an output y of the plant P. Disturbances, for example those that induce a resonance such as described above, are represented by d. The magnitude of the disturbances d may typically be sufficiently large to induce errors in the output y (i.e., jitter and/or vibrations in the motion of the stage 18) mechanic resonances such that system specifications cannot be attained without attenuating control.

The control system may be characterized by having two or more summing points. A feedback summing point 22 is defined upstream of the feedback controller C, and combines the input r less the output y (i.e., r−y). The resulting signal from the feedback summing point 22 is the input to the feedback controller C. A disturbance summing point 24 is defined between the feedback controller C and the plant P, and sums the output from the feedback controller with the disturbance d (i.e., Cₒᵤₜ+d). It will be appreciated that while in practice a disturbance may enter anywhere in the plant, including at the plant input or plant output, for calculation it may be modeled as described herein and illustrated in FIG. 2, i.e., as an equivalent disturbance d entering at summing point 24.

The model closed-loop control system is modeled such that disturbance d is not an input to the feedback controller C, i.e., we do not assume that the feedback controller is able to directly measure the disturbance.

The feedback controller C is a non-minimum phase controller, and at least some of its zeros are in the right-half plane. Moreover, it exhibits a high gain at the resonance frequencies which the disturbance induces, and the feedback controller causes a phase of about −360° of the open-loop at one or more of the resonance frequencies.

It will be appreciated that the phase of about −360° is provided by way of example only, and in practice the phase of the open-loop may be within a tolerance thereof. According to some examples, the maximum tolerance is +90°, but phases which are within smaller tolerances may provide better attenuation. Moreover, the feedback controller may be configured to cause a phase of the open-loop at each of the resonance frequencies of about a positive-integer multiple of −360°, i.e., about −720°, about −1080°, about −1440°, etc., or within a tolerance thereof as described above.

The control system may be characterized by the following transfer function modeling the output y for a given input r:

$$\frac{y}{r} = \frac{C ( s ) P ( s )}{1 + C ( s ) P ( s )} \qquad ( 1 )$$

In addition, the control system may be characterized by the following transfer function modeling the effect of a disturbance d on the output y:

$$\frac{y}{d} = \frac{P ( s )}{1 + C ( s ) P ( s )} \qquad ( 2 )$$

As the gain of the feedback controller C is sufficiently large at the resonance frequencies of the plant P, such that the value of C(s)P(s)>>1, and thus the value of the denominator approximates C(s) P(s). Accordingly, the right side of equation (1) approaches 1, i.e., the feedback controller C in the closed-loop control system described above with reference to and illustrated in FIG. 2 does not significantly affect normal operation of the system 10 under normal circumstances.

Similarly, as the gain of the feedback controller C is sufficiently large at the resonance frequencies of the plant P, such that the value of C(s)P(s)>>1, the right side of equation (2) approaches 1/C(s), which has a very small value, i.e., the feedback controller C in the closed-loop control system described above with reference to and illustrated in FIG. 2 is able to attenuate errors, even if they are of a large magnitude. Moreover, it will be appreciated that as the feedback controller C causes a phase of about −360° in the open-loop at each of the resonance frequencies for which the non-minimum phase element in the controller is designed, the attenuation of resonance-induced errors is applied quickly.

Moreover, as the feedback controller C is capable of attenuating large errors, it may facilitate scanning at greater speeds. For examples, at elevated speeds of the stage 18, large errors which would otherwise affect the scanning are attenuated, thereby facilitating faster overall scanning.

It will be appreciated that while the presently disclosed subject matter is described with reference to parallel lines which are scanned in successively opposite directions, this is by way of example only, and in practice the stage mechanism may be configured to move the stage 18 in any suitable pattern for scanning, including, but not limited to, raster scanning (i.e., wherein the sample is returned to the original position along the Y-axis at to begin scanning each line), scanning along non-parallel lines, etc. In general, the presently disclosed subject matter relates to systems 10 in which the direction of movement of, e.g., the stage 18, substantively reverses direction prior to scanning. Such a change of direction may give rise to a disturbance, which may for cause jitter, which could negatively impact the scanning.

While the term “controller” is used herein the specification and appended claims in a manner suggesting a single element, this is done to increase the intelligibility of the disclosure and of the scope of the claims. In practice, references herein to a controller, i.e., to the system controller and/or to the feedback controller, include, but are not limited to, a single element and/or a combination of elements which may or may not be in physical proximity to one another, which without departing from the scope of the presently disclosed subject matter, mutatis mutandis. Moreover, references herein (including recitation in the appended claims) of a controller carrying out, being configured to carry out, and/or other similar language, implicitly include other elements of the system 10 carrying out, being configured to carry out, etc., those functions, alone or in concert with the referenced controller, without departing from the scope of the presently disclosed subject matter, mutatis mutandis.

It will be recognized that examples, embodiments, modifications, options, etc., described herein are to be construed as inclusive and non-limiting, i.e., two or more examples, etc., described separately herein are not to be construed as being mutually exclusive of one another or in any other way limiting, unless such is explicitly stated and/or is otherwise clear. Those skilled in the art to which this invention pertains will readily appreciate that numerous changes, variations, and modifications can be made without departing from the scope of the presently disclosed subject matter, mutatis mutandis.

1. An inspection system configured to scan a sample, the inspection system comprising:
a scanning arrangement configured to image one or more physical parameters of the sample;
a stage configured to maintain the sample in a suitable position relative to the scanning arrangement during operation thereof;
one or more actuators configured to effect relative motion between the sample and the scanning arrangement;
a system controller being configured to direct operation of the inspection system; and
a feedback controller configured to attenuate errors arising from relative motion-induced disturbances, the feedback controller being a non-minimum phase controller having one or more zeros in the right-half plane.

2. The inspection system according to claim 1, wherein the actuators are piezoelectric actuators.

3. The inspection system according to claim 1, wherein the feedback controller and moving elements of the inspection system constitute a closed-loop control system, in which the moving elements of the inspection system constitute a plant of the closed-loop control system.

4. The inspection system according to claim 1, the one or more actuators being characterized by one or more resonance frequencies, the feedback controller being further characterized by a high gain and by a phase shift which gives rise to an open-loop frequency response of the system having a phase which is a positive-integer multiple of −360°, ±90°, at each of the resonance frequencies.

5. (canceled)

6. The inspection system according to claim 4, wherein the open-loop frequency response of the system has a phase which is a positive-integer multiple of −360°, ±15°, at each of the resonance frequencies.

7. The inspection system according to claim 4, wherein the open-loop frequency response of the system has a phase which is a positive-integer multiple of substantially −360° at each of the resonance frequencies.

8. The inspection system according to claim 4, wherein the positive integer is 1.

9. The inspection system according to claim 4, the feedback controller being characterized by a transfer function C(s), the plant being characterized by a transfer function P(s), wherein the closed-loop control system is characterized by:
$$\frac{y}{r} = \frac{C ( s ) P ( s )}{1 + C ( s ) P ( s )} ,$$
in which y is the movement of the stage relative to the scanning arrangement, and r is the directions provided by the system controller regarding movements of the one or more actuators.

10. The inspection system according to claim 9, wherein the closed-loop control system is further characterized by:
$$\frac{y}{d} = \frac{P ( s )}{1 + C ( s ) P ( s )} ,$$
in which dis the equivalent disturbance.

11. The inspection system according to claim 4, wherein inputs to the plant comprise the output of the feedback controller and the disturbance.

12. The inspection system according to claim 4, wherein inputs to the feedback controller comprise directions provided by the system controller regarding movements of the one or more actuators, and negative of the output of the plant.

13. (canceled)

14. (canceled)

15. The inspection system according to claim 1, further comprising a stage mechanism comprising the stage and the one or more actuators.

16. The inspection system according to claim 1, wherein the one or more actuators are configured, during scanning, to move the sample linearly in a first direction, and to subsequently reverse direction to move the sample linearly in a second direction being opposite the first direction.

17. The inspection system according to claim 16, the one or more actuators being further configured, after linearly moving the sample in the first direction, to shift the sample in a direction being perpendicular to the first and second linear directions.

18. The inspection system according to claim 16, wherein disturbances arise from the reversal of direction.

19. The inspection system according to claim 1, wherein the one or more actuators are configured, during scanning, to move the sample rotationally, wherein disturbances arise from the rotation.

20. The inspection system according to claim 1, being configured to attenuate residual errors remaining after motion has stopped.

21. The inspection system according to claim 1, the stage being characterized by a resonance frequency about one or more axes thereof, the feedback controller being configured to attenuate errors having a frequency substantially that of the resonance frequency and/or disturbance causing them.

22. The inspection system according to claim 1, wherein the scanning arrangement is configured to implement scanning electron microscopy, scanning tunneling microscopy, scanning photon microscopy, atomic force microscopy, soft X-ray metrology, X-ray reflectometry, X-ray tomography, X-ray diffraction, coherent diffractive imaging, ptychography, and/or extreme ultraviolet metrology.

23. The inspection system according to claim 1, the scanning arrangement comprising an aperture via which signals from the samples are collected for detection, wherein the one or more actuators are configured to effect relative motion between the sample and the scanning aperture.

24. (canceled)

25. (canceled)

26. (canceled)
